(19) United States
(12) Patent Application Publication
(10) Pub. No.: US 2026/0169925 A1
(43) Pub. Date: Jun. 18, 2026

(54) DATA STORAGE DEVICE AND COMPUTING SYSTEM

(71) Applicant: SK hynix Inc., Icheon-si (KR)

(72) Inventor: Hui Jae YU, Icheon-si (KR)

(21) Appl. No.: 19/242,366

(22) Filed: Jun. 18, 2025

(30) Foreign Application Priority Data
Dec. 17, 2024 (KR) 10-2024-0187855

(51) Int. Cl. G06F 12/109

(52) U.S. Cl. CPC G06F 12/109

(57) ABSTRACT

An inverted page table including mapping information between a physical address of a first memory, included in a data storage device and used for processing data of a host device, and a logical address of at least a partial storage area of a second memory having a size larger than the first memory is disclosed. A storage virtual memory may be provided to the host device, and by expanding the size of a physical memory recognized by the host device, the performance of data processing of the host device may be improved.

### CROSS-REFERENCE TO RELATED APPLICATION

The present application claims priority under 35 U.S.C. §119(a) to Korean Patent Application No. 10-2024-0187855 filed in the Korean Intellectual Property Office on December 17, 2024, which is incorporated herein by reference in its entirety.

### BACKGROUND

### 1. Technical Field

Embodiments of the present disclosure relate to a data storage device and a computing system.

### 2. Related Art

A computing system may include a processor that performs data processing and a memory that provides a storage area required by the processor to process data. The processor may be allocated a storage area of the memory and perform data processing using the allocated storage area.

As the case may be, the processor may perform data processing according to a plurality of applications, and such cases, may be allocated a storage area for each of the plurality of applications and perform data processing.

When performing data processing according to the plurality of applications by the processor, a problem may arise in that the storage area that can be provided may be insufficient due to a limit in the size of the memory and, when the size of a storage area required for the data processing is large, data processing using the allocated memory may be difficult.

### SUMMARY

Embodiments of the present disclosure are directed to providing measures capable of improving the performance of data processing by a processor by providing the effect of expanding the size of a physical storage area that the processor performing data processing in a computing system may be allocated through a memory.

In an embodiment, a data storage device may include: a first memory; a second memory; and a controller configured to provide a storage virtual memory of a size corresponding to at least a partial storage area of the second memory, and configured to process a page request from a host device for the first memory using an inverted page table, which includes mapping information between a logical address from the storage virtual memory and a physical address of the first memory.

In an embodiment, a data storage device may include: a first memory; and a controller configured to provide a storage virtual memory of a size corresponding to at least a partial storage area of a second memory, which is distinguished from the first memory, and to process a page request from a host device by using an inverted page table which includes mapping information between a logical address according to the storage virtual memory and a physical address of the first memory.

In an embodiment, a computing system may include: a data storage device including a first memory; and a host device configured to perform data processing using the data storage device, wherein the host device recognizes a storage virtual memory of a size corresponding to at least a partial storage area of a second memory, which is distinguished from the first memory, as a physical memory, and performs data processing by using an inverted page table that includes mapping information between a logical address according to the storage virtual memory and a physical address of the first memory.

According to the embodiments of the present disclosure, by expanding the physical size of a memory recognizable by a processor, when processing an allocation request for a storage area and a page request by the processor, the load and delay time of the processor may be reduced, and the performance of data processing may be improved.

### BRIEF DESCRIPTION OF THE DRAWINGS

FIG. 1 is a diagram illustrating a schematic configuration of a data storage device according to embodiments of the present disclosure.

FIG. 2 is a diagram illustrating a schematic configuration of a data storage device that provides a virtual memory according to embodiments of the present disclosure.

FIG. 3 is a diagram illustrating a schematic configuration of a data storage device that provides a storage virtual memory according to embodiments of the present disclosure.

FIG. 4 is a diagram illustrating a scheme in which a data storage device configures a storage virtual memory according to the embodiments of the present disclosure.

FIG. 5 is a diagram illustrating operations of a data storage device that provides a storage virtual memory 400 according to embodiments of the present disclosure.

FIG. 6 is a diagram illustrating an operation of a data storage device when a miss for a page request occurs when using a storage virtual memory according to the embodiments of the present disclosure.

FIG. 7 is a diagram illustrating examples in which a data storage device processes a page request when using a storage virtual memory according to embodiments of the present disclosure.

FIG. 8A and FIG. 8B are diagrams illustrating an operation of a data storage device checking usage state information using an inverted page table according to embodiments of the present disclosure.

FIG. 9 is a diagram illustrating various examples of a storage virtual memory according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present disclosure, detailed descriptions of well-known functions and components incorporated herein will be omitted when it is determined that the description may make the subject matter in some embodiments of the present disclosure more unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element "is connected or coupled to", “contacts or overlaps” etc. a second element, it should be interpreted that, not only can the first element “be directly connected or coupled to” or “directly contact or overlap” the second element, but a third element can also be "interposed" between the first and second elements, or the first and second elements can "be connected or coupled to", “contact or overlap”, etc. each other via a fourth element. Here, the second element may be included in at least one of two or more elements that "are connected or coupled to", “contact or overlap”, etc. each other.

When time relative terms, such as "after," "subsequent to," "next," "before," and the like, are used to describe processes or operations of elements or configurations, or flows or steps in operating, processing, or manufacturing methods, these terms may be used to describe non-consecutive or non-sequential processes or operations unless the term "directly" or "immediately" is used together.

In addition, when any dimensions, relative sizes etc. are mentioned, it should be considered that numerical values for elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can.”

Hereinafter, various embodiments of the present disclosure will be described in detail with reference to accompanying drawings.

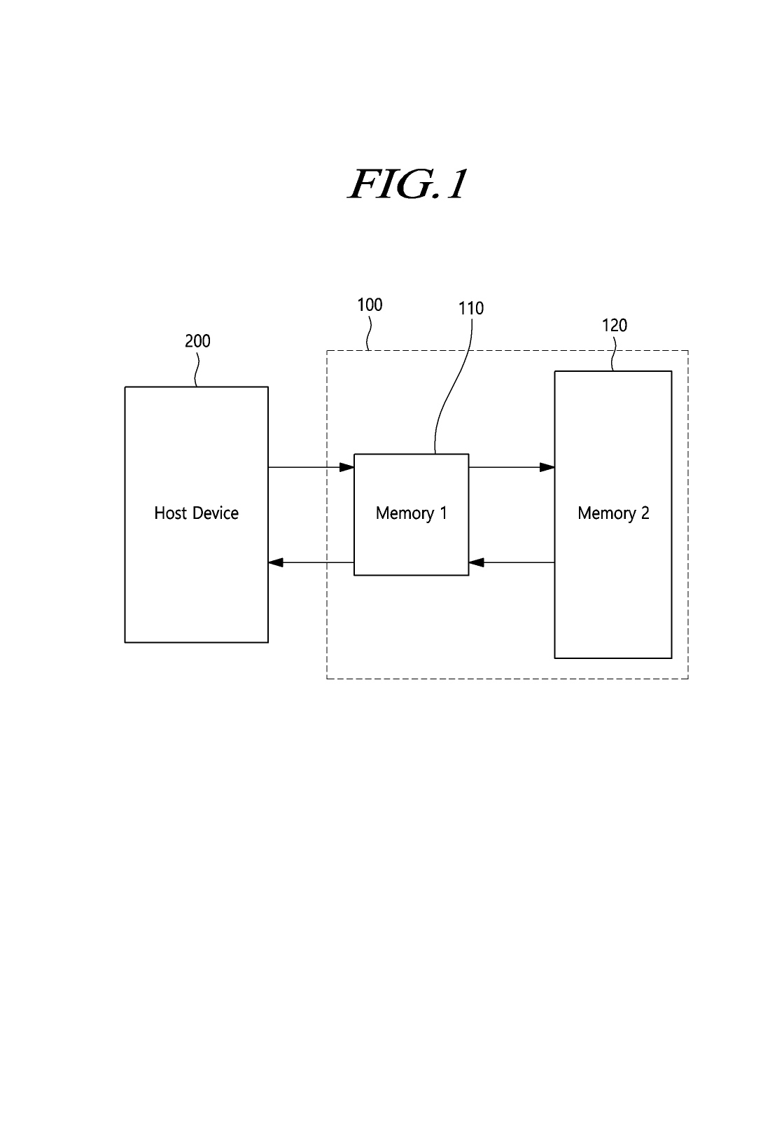

FIG. 1 is a diagram illustrating a schematic configuration of a data storage device according to embodiments of the present disclosure.

Referring to FIG. 1, a data storage device 100 may include at least one memory. For instance, as in the example illustrated in FIG. 1, the data storage device 100 may include a first memory 110 and a second memory 120. One of the first memory 110 and the second memory 120 may be located outside the data storage device 100.

The types of the first memory 110 and the second memory 120 may be the same as or different from each other.

For example, the first memory 110 may be volatile memory and the second memory 120 may be nonvolatile memory.

The first memory 110 may be, for example, DRAM, SDRAM, DDR SDRAM or LPDDR SDRAM, but embodiments of the present disclosure are not limited thereto. The second memory 120 may be NAND flash memory, 3D NAND flash memory or NOR flash memory, but embodiments of the present disclosure are not limited thereto. In some embodiments, at least one of the first memory 110 and the second memory 120 may be one of various memories such as resistive RAM, phase change memory (PCRAM), magneto-resistive memory (MRAM), ferroelectric memory and spin transfer torque magnetic memory. In other embodiments, at least one of the first memory 110 and the second memory 120 may be selector only memory (SOM), which is emerging as a type of memory. An SOM may be a type of memory in which a memory cell is constituted by only a selector (e.g., a transistor). In yet other embodiments, at least one of the first memory 110 and the second memory 120 may be processing-in-memory that includes a computation function or a data processing function, analog compute-in-memory (ACiM), etc.

The data storage device 100 may include a controller that controls the operation of at least one of the first memory 110 and the second memory 120. A controller that controls the first memory 110 and a controller that controls the second memory 120 may be integrated with each other or may be disposed separately from each other. At least a part of the function of the controller may be performed by an external device, and the first memory 110 or the second memory 120 may operate under the control of the external device.

According to a request from an external device, the data storage device 100 may allocate a storage area of the first memory 110. For example, the data storage device 100 may receive an allocation request from the host device 200 and allocate at least a part of the storage area of the first memory 110. The host device 200 and the data storage device 100 may be collectively referred to as a computing system.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, a radio frequency identification (RFID) device, a mobility device (e.g., a vehicle, a robot or a drone) capable of traveling under human control or autonomous driving, etc. Alternatively, the host device 200 may be a virtual/augmented reality device that provides a 2D or 3D virtual reality image or augmented reality image. In addition, the host device 200 may be any one of various electronic devices that requires the data storage device 100 to be capable of storing data.

The host device 200 may include at least one operating system. The operating system may manage and control overall functions and operations of the host device 200, and may control an interoperation between the host device 200 and the data storage device 100. An operating system may be classified into a general operating system and a mobile operating system depending on the mobility of the host device 200.

According to a request from the host device 200, the data storage device 100 may allocate a storage area of the first memory 110. When receiving a page request requesting data from the host device 200, the data storage device 100 may provide a page stored at an address corresponding to the page request to the host device 200.

When the storage area of the first memory 110 is insufficient, the data storage device 100 may store and manage at least a part of data stored in the first memory 110 in the second memory 120. For example, the data storage device 100 may store data that is not frequently used in the second memory 120. When a page request for data stored in the second memory 120 is received, the data storage device 100 may load the data stored in the second memory 120 into the first memory 110 and then provide the requested data to the host device 200.

The data storage device 100 may provide a virtual memory so that the host device 200 may recognize the physical size of the first memory 110 to be larger than its actual size when performing an allocation request and data processing. The host device 200 may transmit an allocation request and a page request to the data storage device 100 consistent with the size of the virtual memory.

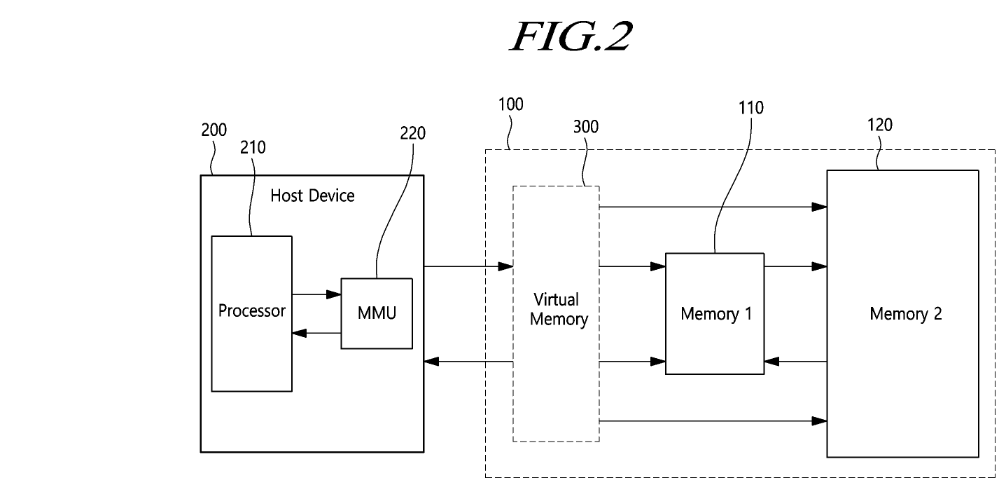

FIG. 2 is a diagram illustrating a schematic configuration of a data storage device that provides a virtual memory according to embodiments of the present disclosure.

Referring to FIG. 2, a data storage device 100 may include a first memory 110 and a second memory 120. The data storage device 100 may also provide a virtual memory 300. The size of the virtual memory 300 may be larger than actual the size of the first memory 110. The size of the first memory 110 may be smaller than the size of the second memory 120.

An address in the virtual memory 300 may correspond to an address of a storage area included in the first memory 110 or an address of a storage area included in the second memory 120. When the host device 200 transmits an allocation request and a page request using an address of the virtual memory 300, the data storage device 100 may allocate a storage area by checking the correspondence relationships, in the virtual memory 300, among the received address, the first memory 110 and the second memory 120. The data storage device 100 then provides a page according to the page request to the host device 200.

The host device 200 may include a processor 210 and a memory management unit 220. The processor 210 may perform a computation, etc. according to data processing by the host device 200. In order to perform data processing according to a plurality of applications operating in the host device 200, the processor 210 may request allocation of a storage area to the data storage device 100 and perform data processing using the allocated storage area.

In order to process an allocation request for a storage area and a page request from the processor 210, the memory management unit 220 may manage the mapping relationships between virtual addresses from the processor 210 and physical addresses used by the data storage device 100. When receiving a virtual address from the processor 210, the memory management unit 220 may check a physical address of the data storage device 100 that is mapped to the virtual address. The memory management unit 220 may transmit the physical address, which is translated using the virtual address, to the data storage device 100.

The data storage device 100 may receive a physical address mapped to the virtual address provided by the memory management unit 220 and check a storage area corresponding to the physical address. The data storage device 100 may check a storage area of the first memory 110 mapped to the physical address using the virtual memory 300. For example, the virtual memory 300 may include a logical address and may access a physical address of the first memory 110 using the logical address corresponding to the physical address transmitted by the host device 200. In this example, the data storage device 100 may provide data of the storage area of the first memory 110 to the host device 200.

When a storage area of the first memory 110 mapped through the virtual memory 300 does not exist, the data storage device 100 may check a storage area of the second memory 120 mapped to the virtual memory 300. The data storage device 100 may load data of the second memory 120 into the first memory 110 and provide the data to the host device 200.

Since the data storage device 100 allocates a storage area using the virtual memory 300 and provides the storage area to the host device 200, the host device 200 may perform data processing while requesting allocation of a storage area on the assumption that the virtual memory 300 is larger than the first memory 110.

In addition, by allowing the host device 200 to recognize the virtual memory 300 as a physical memory included in the data storage device 100, the data storage device 100 according to the embodiments of the present disclosure may expand the size of the virtual memory 300 recognized by the host device 200 and reduce the load of the host device 200 when performing data processing.

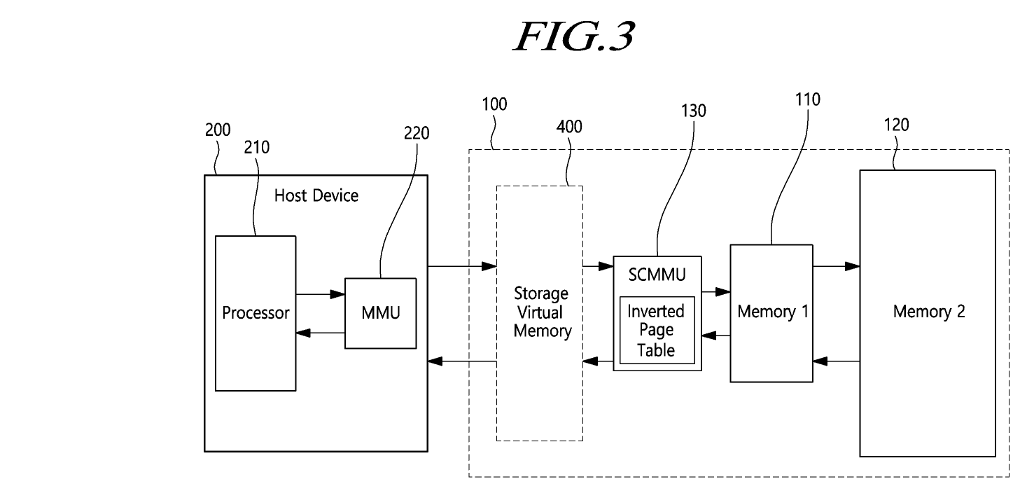

FIG. 3 is a diagram illustrating a schematic configuration of a data storage device that provides a storage virtual memory according to embodiments of the present disclosure.

Referring to FIG. 3, a data storage device 100 may include a first memory 110 and a second memory 120. The first memory 110 may be volatile memory and the second memory 120 may be nonvolatile memory. The size of the second memory 120 may be larger than the size of the first memory 110. While FIG. 3 illustrates a data storage device 100 including one first memory 110 and one second memory 120 as described above, and the type and number of memories included in the data storage device 100 may vary in other embodiments.

The data storage device 100 may include a storage memory management unit 130. The mapping relationship between a storage virtual memory 400 provided to a host device 200 and the first memory 110 and the second memory 120 may be managed through the storage memory management unit 130.

For example, the storage memory management unit 130 may generate and manage an inverted page table that includes mapping information between a logical address in the storage virtual memory 400 and a physical address of the first memory 110. The storage memory management unit 130 may manage the mapping relationship between the storage virtual memory 400 and the first memory 110 using the inverted page table.

The data storage device 100 may provide the storage virtual memory 400 to the host device 200 while using the inverted page table managed by the storage memory management unit 130 to manage the mapping relationships between the storage virtual memory 400 and memory in the data storage device 100.

The host device 200 may include a processor 210 and a memory management unit 220. The memory management unit 220 may detect a storage area of the data storage device 100 presented by the storage virtual memory 400. When receiving a virtual address from the processor 210, the memory management unit 220 may transmit a physical address mapped by the virtual address to the data storage device 100. The data storage device 100 may check a logical address of the storage virtual memory 400 mapped to the physical address and check a storage area of the first memory 110 using the logical address.

The data storage device 100 may process an allocation request and a page request from the host device 200, which accesses the data storage device 100 through the storage virtual memory 400, and may provide data (a page) stored in the storage area of the first memory 110 corresponding to the virtual address provided from the host device 200 to the data storage device 100.

When the data storage device 100 provides, to the host device 200, a storage virtual memory 400 that is managed with the inverted page table, the host device 200 may assume that the size of a physical memory provided by the data storage device 100 is expanded. Because the host device 200 detects a storage virtual memory 400 that appears larger than the size of the actual physical memory of the data storage device 100, additional load that results from an insufficient size of an actual physical memory detected when the host device 200 processes data can be reduced or avoided.

The memory management unit 220 of the host device 200 recognizes the storage virtual memory 400 as a large-sized physical memory and may perform an allocation request and a page request when the size of a storage area required by the host device application is large. As a result, consecutive addresses may be allocated in response to a request by the processor 210 as processed by the memory management unit 220.

For example, the data storage device 100 may generate an inverted page table while mapping a logical address of at least a partial storage area of the second memory 120 to a physical address of the first memory 110. The inverted page table may be used to provide the storage virtual memory 400.

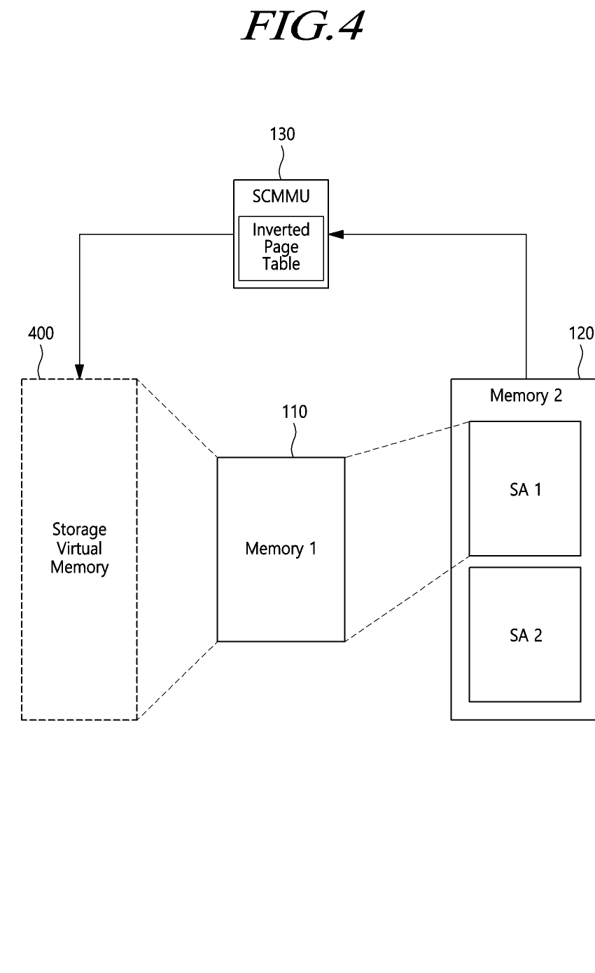

FIG. 4 is a diagram illustrating a scheme in which a data storage device configures a storage virtual memory according to the embodiments of the present disclosure.

Referring to FIG. 4, a second memory 120 of a data storage device 100 may include a plurality of storage areas. At least a part of the plurality of storage areas of the second memory 120 may be used in configuring a storage virtual memory 400.

For example, the second memory 120 may include a first storage area SA1 and a second storage area SA2. The storage virtual memory 400 may be configured using the first storage area SA1 of the second memory 120.

The storage memory management unit 130 may generate an inverted page table by mapping a logical address associated with the first storage area SA1 of the second memory 120 and a physical address of the first memory 110. The storage memory management unit 130 may provide the storage virtual memory 400, which has a size corresponding to the size of the first storage area SA1 of the second memory 120, by using the inverted page table.

For example, when the size of the second memory 120 is 512G and the size of the first storage area SA1 is 256G, the size of the storage virtual memory 400 provided using the inverted page table may be 256G. The memory management unit 220 of the host device 200 may recognize the size of a physical memory provided by the data storage device 100 as 256G. Since the memory management unit 220 recognizes the size of the physical memory provided by the data storage device 100 as 256G and performs an allocation request and a page request requesting to read data for an allocated storage area, even when the processor 210 of the host device 200 performs data processing that requires a large storage area, the data processing may be easily performed using a storage area provided through the storage virtual memory 400.

In this way, the data storage device 100 may expand the size of a physical memory provided by the data storage device 100 while providing the storage virtual memory 400 to the host device 200 using the inverted page table.

The memory management unit 220 of the host device 200 may transmit a page request to the data storage device 100 using at least one page table including mapping information between a virtual address provided by the host device 200 and a logical address according to the storage virtual memory 400.

The data storage device 100 may process a page request received from the host device 200 using at least one page table and the inverted page table.

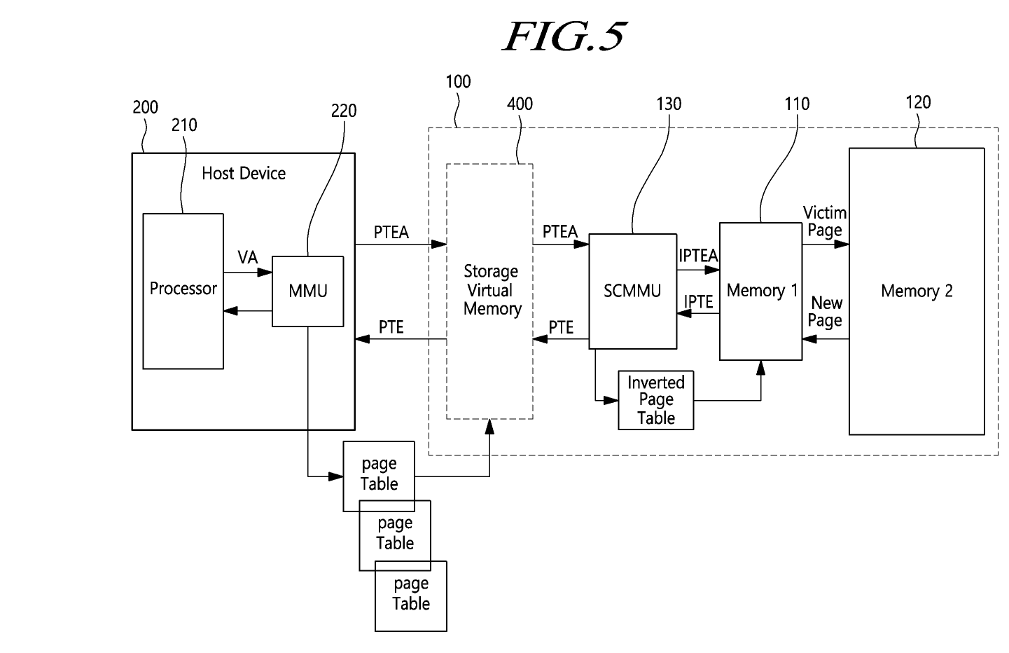

FIG. 5 is a diagram illustrating operations of a data storage device 100 that provides a storage virtual memory 400 according to embodiments of the present disclosure.

Referring to FIG. 5, a data storage device 100 may include a first memory 110, a second memory 120 and a storage memory management unit 130. The data storage device 100 may provide a storage virtual memory 400 by using an inverted page table including mapping information between a logical address of at least a partial storage area of the second memory 120 and a physical address of the first memory 110. A host device 200 may detect an expanded physical memory of the data storage device 100 through the storage virtual memory 400.

The host device 200 may include a processor 210 and a memory management unit 220. The memory management unit 220 may request the data storage device 100 to allocate a storage area for each application performed by the processor 210. The memory management unit 220 may use a page table to manage information on a storage area allocated by the data storage device 100.

The memory management unit 220 may detect or recognize the size of the physical memory of the data storage device 100 represented by the storage virtual memory 400 and process a request of the processor 210. The memory management unit 220 may transmit a physical address to the data storage device 100 through a page table for each application in operation in the host device 200.

For example, the processor 210 may provide a virtual address to the memory management unit 220. The memory management unit 220 may transmit a physical address corresponding to the virtual address through a page table to the data storage device 100. The storage memory management unit 130 of the data storage device 100 may check a physical address of the first memory 110 which is mapped through the inverted page table to a logical address of the storage virtual memory 400, which is associated with the received physical address.

The storage memory management unit 130 may provide data (a page) of a corresponding storage area in the first memory 110 to the host device 200 using the inverted page table. When data does not exist in a storage area of the first memory 110 mapped using the inverted page table, the storage memory management unit 130 may load data into the first memory 110 from the second memory 120 and provide the loaded data to the host device 200. Since data that is missing in the first memory 110 against the address provided by the host device 200 is checked inside the data storage device 100 by the storage memory management unit 130 and an address is provided to the host device 200, the host device 200 may perform data processing using the data storage device 100 without an increase in load.

When a miss for a page request by the memory management unit 220 of the host device 200 occurs or a miss for a page request by the storage memory management unit 130 of the data storage device 100 occurs, a fault handling operation may be performed by a fault handler of the host device 200. The fault handling operation may be performed differently depending on the type of miss.

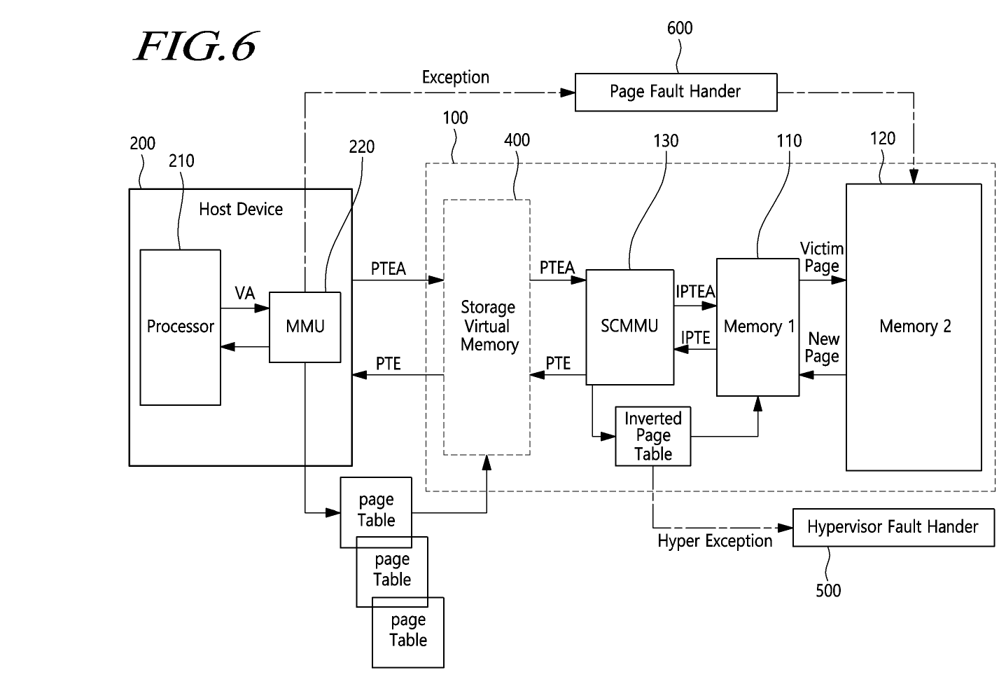

FIG. 6 is a diagram illustrating operations of a data storage device when a miss for a page request occurs when using a storage virtual memory according to the embodiments of the present disclosure.

Referring to FIG. 6, a storage memory management unit 130 of a data storage device 100 may provide a storage virtual memory 400 which has a size corresponding to the size of at least a part of the storage area of a second memory 120, by using an inverted page table including mapping information between a logical address of the at least a part of the storage area of the second memory 120 and a physical address of the first memory 110.

A memory management unit 220 of a host device 200 may receive a virtual address from a processor 210 and transmit a physical address mapped to the virtual address to the data storage device 100 through a page table.

The data storage device 100 may check a logical address of the storage virtual memory 400 mapped to the received physical address, and may provide data of at a physical address of the first memory 110 indicated by the logical address to the host device 200.

The data storage device 100 may use the inverted page table to check mapping information between the logical address of the storage virtual memory 400 and the physical address of the first memory 110. The data storage device 100 may check a storage area of the first memory 110 using the inverted page table and provide data from the first memory 110 to the host device 200.

When a miss occurs during a process in which the data storage device 100 searches for a physical address of the first memory 110 using the inverted page table, a fault handling operation may be performed. For example, when a miss occurs, a fault handling operation is performed by a hypervisor fault handler 500 included in the host device 200.

The data storage device 100 may transmit a miss that occurs during processing of a page request to the host device 200, and a fault handling operation in which missed data is checked in the second memory 120 and the corresponding data is loaded into the first memory 110 may be performed by the hypervisor fault handler 500 of the host device 200. According to the fault handling operation, data may be loaded to a physical address of the first memory 110, and consequently the inverted page table may be updated.

Since the data storage device 100 in effect provides an expanded size of a physical memory (e.g., data can be in physical addresses in the first memory 110 or the second memory 120) which may be recognized by the host device 200, the occurrence of a miss when performing a search using a page table in the host device 200 may be lowered. In addition, when a miss occurs during a search for a page table by the memory management unit 220 of the host device 200, a fault handling operation by a page fault handler 600 of the host device 200 may be performed.

For a page miss in a page table that occurs with a low probability, a fault handling operation may be performed by the page fault handler 600. For a page miss in the inverted page table managed by a storage memory management unit 130, a fault handling operation may be performed by the hypervisor fault handler 500. Fault handling by the page fault handler 600 is different from fault handling performed by the hypervisor fault handler 500in the case of a page miss in a page table. When the fault handling operation is performed by a page fault handler 600, for example, to search for a missed page in a second memory 120, the missed page may be loaded into the first memory 110, and an update to the inverted page table may be performed.

Embodiments of the present disclosure may improve the data processing performance of the host device 200 by expanding the perceived size of a physical memory recognized by the host device 200 through use of the storage virtual memory 400 provided by the storage memory management unit 130 of the data storage device 100, and when a page miss occurs, embodiments of the present disclosure may efficiently process the page miss by performing a fault handling operation using the hypervisor fault handler 500 or the page fault handler 600 depending on the type of the page miss.

A miss in a page request for the data storage device 100 may occur in various types, and a scheme for processing the miss may differ depending on each type of miss.

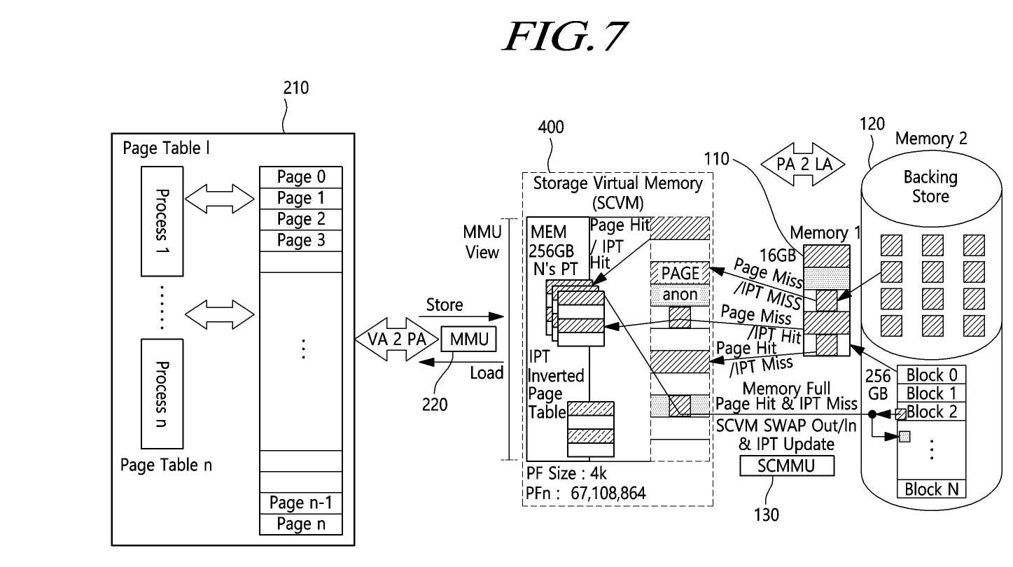

FIG. 7 is a diagram illustrating examples in which a data storage device processes a page request when using a storage virtual memory according to embodiments of the present disclosure.

Referring to FIG. 7, a processor 210 of a host device 200 may process a plurality of processes and manage a page table for each of the plurality of processes. When processing a page request for each of the plurality of processes, the processor 210 may use a virtual address. A memory management unit 220 may check a physical address mapped to the virtual address using a page table in the processor 210, and may transmit the physical address obtained from the page table to the data storage device 100.

The data storage device 100 may include a first memory 110, a second memory 120 and a storage memory management unit 130, and may provide a storage virtual memory 400 associated with at least a partial storage area of the second memory 120.

The data storage device 100 may perform processing according to a page request from the host device 200, namely using a physical address received from the host device 200 and finding an associated logical address in the storage virtual memory 400.

A data storage device 100 processing a page request from the host device 200 may get a hit or a miss during a process of searching for a table.

For example, when handling a page request, and a hit occurs in a page table in the processor 210 and a hit occurs in an inverted page table in the data storage device 100, the data storage device 100 may provide the page indicated by a logical address hit in the storage virtual memory 400 to the host device 200.

When handling a page request, and a hit occurs in a page table but a miss occurs in the inverted page table, the data storage device 100 may load a page stored in the second memory 120 into the first memory 110 and provide the loaded page to the host device 200. The data storage device 100 may update the inverted page table on the basis of the loaded page.

When handling a page request, and a miss occurs in a page table and a hit occurs in the inverted page table, the data storage device 100 may provide a page indicated by a physical address of the first memory 110 mapped to a logical address hit in the inverted page table to the host device 200.

When handling a page request, and the page request misses in a page table and misses in the inverted page table, the data storage device 100 may load a page stored in the second memory 120 into the first memory 110 and provide the loaded page to the host device 200.

When a miss occurs in each of a page table and the inverted page table, a fault handling operation by a hypervisor fault handler 500 (not illustrated) of the host device 200 may be performed. According to the fault handling operation, a page stored in the second memory 120 may be loaded into the first memory 110 and provided to the host device 200, and a page table and the inverted page table may be updated.

The memory management unit 220 of the host device 200 may transmit a page request to the data storage device 100 by using a page table, and may transmit the page request in recognition of the expanded size of a physical memory embodied by the storage virtual memory 400, which is provided by the data storage device 100.

When a miss of a page according to a page request occurs, since a page can be provided using the first memory 110 and the second memory 120, the load of the host device 200 for processing the miss situation may be reduced, and the performance of data processing of the host device 200 may be improved.

In addition, by using the inverted page table, the storage memory management unit 130 of the data storage device 100 may efficiently manage a storage area used by each process of the host device 200 and facilitate the necessary storage areas in response to host requests.

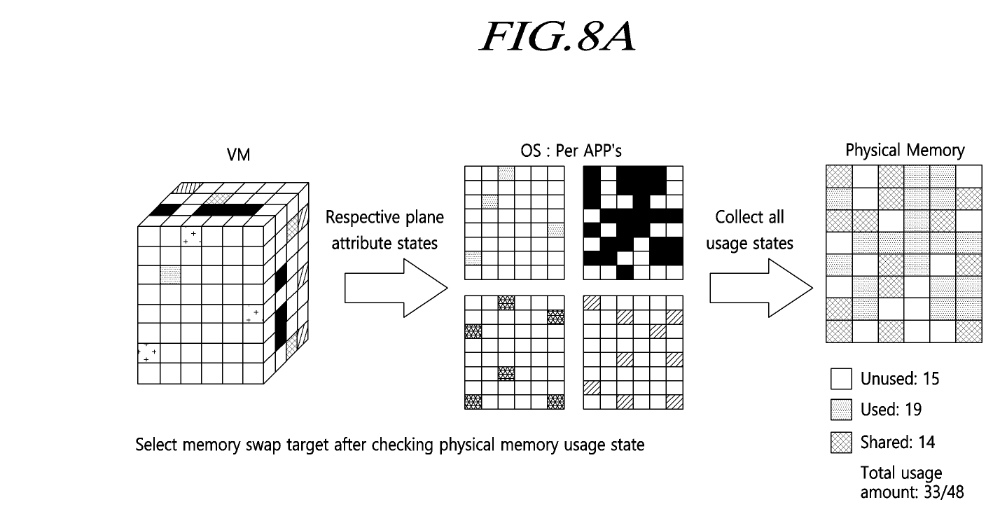

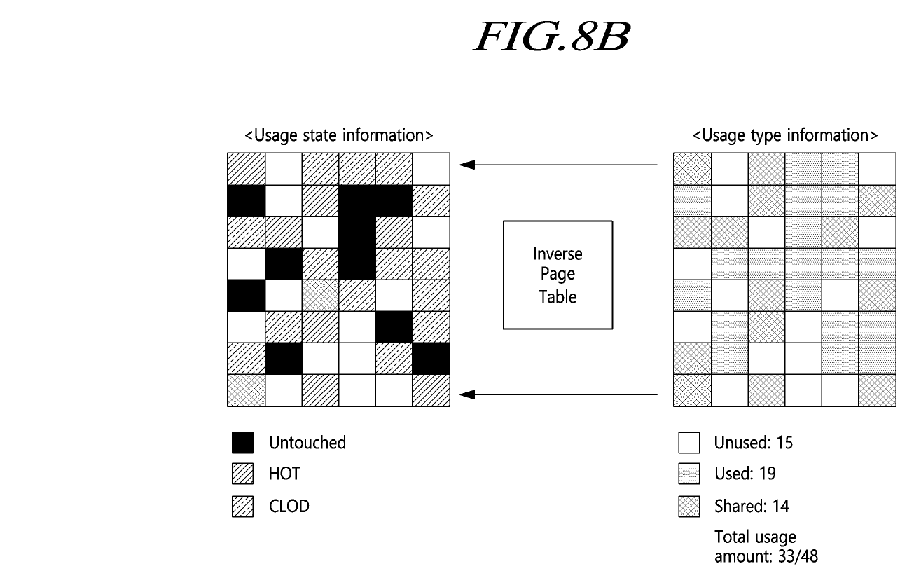

FIG. 8A and FIG. 8B are diagrams illustrating an operation of a data storage device checking usage state information using an inverted page table according to embodiments of the present disclosure.

Referring to FIG. 8A, a processor 210 of a host device 200 may process a plurality of processes. The plurality of processes may be processes respectively performed by a plurality of applications, or may be processes performed by a single application.

A process performed by each application may be referred to as a virtual machine (VM), and a storage area of the data storage device 100 may be allocated for each virtual machine.

A storage area allocated for each virtual machine may be represented as in the example illustrated in FIG. 8A. For example, each storage area may be used by a single application, may be used by a plurality of applications, or, as the case may be, may not be used. When storage areas allocated for each of a plurality of applications are combined and are represented on a single plane, the storage areas may be represented by being divided into used areas, unused areas and shared areas. Information on the used, shared and unused areas may be referred to as usage type information.

The data storage device 100 may check usage state information of each storage area using the usage type information and an inverted page table.

Referring to FIG. 8B, the data storage device 100 may inversely check, through the inverted page table, usage type information, on the basis of whether a storage area is used by a plurality of applications. The data storage device 100 may check the usage state of each storage area, and may check an actually used area, an unused area and a frequently used area. For example, among storage areas being used and storage areas being shared, the data storage device 100 may check an area where hot data with high usage frequency is stored. The data storage device 100 may check an area where cold data with low usage frequency is stored. In addition, the data storage device 100 may check an area which is allocated for at least one application and where rarely accessed or untouched data is stored.

The data storage device 100 may efficiently use and provide a storage area by performing a new allocation or deallocation of a storage area of the first memory 110 using the usage state information, which is checked on the basis of the usage type information and the inverted page table.

In this way, embodiments of the present disclosure may improve the performance of data processing of the host device 200 by processing a page request from the host device 200 while providing the storage virtual memory 400 by the storage memory management unit 130. The storage memory management unit 130 may be implemented in the data storage device 100 as in the example described above, but alternatively a corresponding function may be provided by the host device 200. The type and number of memories included in the data storage device 100 may be implemented in various ways.

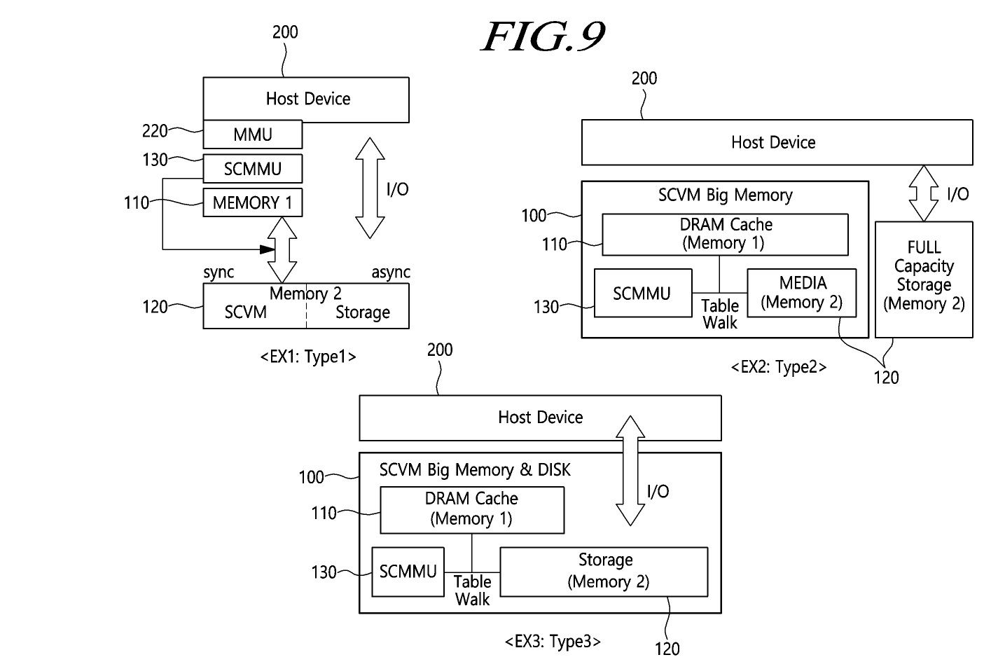

FIG. 9 is a diagram illustrating various examples of a storage virtual memory according to embodiments of the present disclosure.

Referring to FIG. 9, Type 1 represents an example in which a storage virtual memory 400 is implemented by a host device 200, and Type 2 and Type 3 represent examples in which the storage virtual memory 400 is implemented by a data storage device 100.

Referring to Type 1, the functions of a memory management unit 220 and a storage memory management unit 130 may be implemented in the host device 200. The function of the storage memory management unit 130 may be provided by being integrated with the function of the memory management unit 220, or by separately implementation.

The memory management unit 220 may request a page by providing a physical address to the storage memory management unit 130 according to the mapping relationship between a virtual address and a physical address, similarly to an operation of using a virtual memory.

The storage memory management unit 130 may provide the storage virtual memory 400 to the host device 200, and the storage memory management unit 130 may manage the mapping relationship between a logical address of at least a partial storage area of the second memory 120 and a physical address of the first memory 110. In the second memory 120, a storage area used when providing the storage virtual memory 400 may operate in synchronization with the first memory 110, but the remaining storage areas may operate without being synchronized.

According to the Type 1 example, a computing system which uses the storage virtual memory 400 may be provided, in which the function of the storage memory management unit 130 is added while maintaining the configurations of the memory management unit 220 of the host device 200 and the data storage device 100.

In an example of Type 2, the data storage device 100 may include the first memory 110 and the second memory 120. The storage memory management unit 130 is implemented inside the data storage device 100, and the storage virtual memory 400 may be provided to the host device 200. The storage memory management unit 130 may manage mapping information between a logical address of at least a part of the storage area of the second memory 120 and a physical address of the first memory 110, using the inverted page table, to configure the storage virtual memory 400.

The storage memory management unit 130 may provide the storage virtual memory 400, for example, by using a part of the second memory 120 located outside the data storage device 100 or, alternatively, by including a nonvolatile memory that is separate from the second memory 120, which is located outside.

In the Type 3 example, in a structure in which the first memory 110 and the second memory 120 are included inside the data storage device 100, the storage virtual memory 400 detected by the host device 200 is managed by the storage memory management unit 130. The amount of physical memory recognized by the host device 200 may be expanded and provided using the storage virtual memory 400 and the second memory 120. In some embodiments, the first memory 110 included in the data storage device 100 may be used as a cache.

In addition, when detailed tiering of a memory included in the data storage device 100 is required, the above-described embodiments may be further extended. For example, when detailed tiering of memories in third to Nth stages in addition to first and second stages is required, the aforementioned configuration of the data storage device 100 may be extended. In the case of Type 1, an additional memory management unit 220 or storage memory management unit 130 may be configured in an overlapping manner. In the case of Type 2 and Type 3, a larger memory may be configured to be extended to a lower stage.

According to the embodiments of the present disclosure described above, using a storage memory management unit 130 disposed between the memory management unit 220 of the host device 200 and the first memory 110 of the data storage device 100, a storage virtual memory 400 based on the second memory 120 may be provided to the host device 200 to increase the apparent size of a physical memory recognized by the memory management unit 220.

As the host device 200 uses, through expansion, the size of a memory of the data storage device 100, the performance of data processing of the host device 200 may be improved. The load of the host device 200 can be prevented from increasing in operational processes because an effectively larger physical memory is offered to the host device 200, so the performance of a computing system may be improved.

Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the present disclosure as defined in the following claims.

What is claimed is:

1. A data storage device comprising:
a first memory;
a second memory; and
a controller configured to provide a storage virtual memory of a size corresponding to at least a partial storage area of the second memory, and configured to process a page request from a host device for the first memory using an inverted page table, which includes mapping information between a logical address from the storage virtual memory and a physical address of the first memory.

2. The data storage device according to claim 1, wherein the controller processes the page request by receiving a virtual address from the host device, checking a logical address from the storage virtual memory mapped to the virtual address, and checking a physical address of the first memory mapped to the logical address.

3. The data storage device according to claim 1, wherein the controller processes the page request by using at least one page table, which includes mapping information between a virtual address from the host device and the logical address according to the storage virtual memory and the inverted page table.

4. The data storage device according to claim 3, wherein when a page according to the page request from the host device matches a hit in the at least one page table and matches a hit in the inverted page table, the controller provides, to the host device, a page indicated by a logical address, corresponding to the hits, from the storage virtual memory.

5. The data storage device according to claim 3, wherein when a page according to the page request from the host device matches a hit in the at least one page table and misses in the inverted page table, the controller provides a page to the host device by loading a page from the second memory into the first memory and updates the inverted page table.

6. The data storage device according to claim 3, wherein when a page according to the page request from the host device misses in the at least one page table and matches a hit in the inverted page table, the controller provides, to the host device, a page indicated by a physical address of the first memory mapped to a logical address from the inverted page table.

7. The data storage device according to claim 3, wherein when a page according to the page request from the host device misses in the at least one page table and misses in the inverted page table, the controller loads a page stored in the second memory into the first memory and provides the page to the host device.

8. The data storage device according to claim 3, wherein when a page according to the page request from the host device is missed in the at least one page table and the inverted page table, a fault handling operation is performed by a hypervisor fault handler included in the host device.

9. The data storage device according to claim 3, wherein the controller checks usage type information of the physical address of the first memory on the basis of the at least one page table, and checks usage state information of the physical address of the first memory on the basis of the usage type information and the inverted page table.

10. The data storage device according to claim 9, wherein the usage type information includes information on use, sharing and non-use, and the usage state information includes information on hot data, cold data and untouched data.

11. The data storage device according to claim 1, wherein the controller receives the page request, which is transmitted by the host device, and the host device recognizes a physical memory corresponding to the size of the storage virtual memory.

12. The data storage device according to claim 1, wherein the controller receives the page request, which is transmitted by the host device, and the host device recognizes a physical memory corresponding to a size obtained by summing the size of the first memory and the size of the storage virtual memory.

13. The data storage device according to claim 1, wherein the size of the second memory is larger than the size of the first memory.

14. A data storage device comprising:
a first memory; and
a controller configured to provide a storage virtual memory of a size corresponding to at least a partial storage area of a second memory, which is distinguished from the first memory, and to process a page request from a host device by using an inverted page table, which includes mapping information between a logical address according to the storage virtual memory and a physical address of the first memory.

15. The data storage device according to claim 14, wherein the second memory is located outside of the data storage device.

16. A computing system comprising:
a data storage device including a first memory; and
a host device configured to perform data processing using the data storage device,
wherein the host device recognizes a storage virtual memory of a size corresponding to at least a partial storage area of a second memory, which is distinguished from the first memory, as a physical memory, and performs data processing by using an inverted page table that includes mapping information between a logical address according to the storage virtual memory and a physical address of the first memory.

17. The computing system according to claim 16, wherein when a miss occurs in the data processing using the inverted page table, the host device performs a fault handling operation using a hypervisor fault handler.

18. The computing system according to claim 17, wherein when a miss occurs in a page request for the physical memory, the host device performs a fault handling operation using a page fault handler.

19. The computing system according to claim 16, wherein the host device recognizes the size of the first memory and the size of the storage virtual memory as the physical memory.

20. The computing system according to claim 16, wherein the second memory is located outside the data storage device.
